(19) United States
(12) Patent Application Publication
(10) Pub. No.: US 2026/0207017 A1
(43) Pub. Date: Jul. 23, 2026

(54) TISSUE DISPENSERS, BLANKS, AND METHODS OF FORMING THE SAME

(71) Applicant: KIMBERLY-CLARK WORLDWIDE, INC., Neenah, WI (US)

(72) Inventors: HaeIn KIM, Seoul (KR); JungNam KIM, Seoul (KR); YoonJung LEE, Seoul (KR); MinKyung KIM, Seoul (KR); EunJeong KWAK, Seoul (KR); HyoungWoo KIM, Seoul (KR)

(21) Appl. No.: 19/142,819

(22) PCT Filed: Feb. 7, 2023
(86) PCT No.: PCT/US2023/012515

§ 371 Date: Jun. 24, 2025

(51) Int. Cl. A47K 10/20; B31B 50/20; B31B 50/62; B31B 100/00

(52) U.S. Cl. CPC A47K 10/20; B31B 50/20; B31B 50/62; B31B 2100/0024

(57) ABSTRACT

Various implementations include a dispenser for a plurality of sheets of sheet material that can be moved between at least two configurations by folding the dispenser along one or more different fold lines for each configuration. In some implementations, at least one of the configurations reduces the distance between a dispenser opening for accessing the sheets and a top of a sheet stack, which makes it easier for the consumer to access the sheets, as compared to another configuration. Additionally, in some implementations, the shape of the fold lines that allow the dispenser to be folded into non-rectangular prism configurations contributes to a unique look for a dispenser and a blank.

### BACKGROUND

Existing consumer product dispensers, such as facial tissue dispensers, present a variety of problems to consumers. For example, when the number of facial tissues in the dispenser becomes low, it can become more difficult for the user to access the facial tissues within the dispenser. The next tissue dispensed may fail to pull another tissue with it, requiring the user to reach into the dispenser to pull out the next tissue, which becomes more difficult as the stack of tissues within the dispenser gets lower.

Further, consumers have grown accustomed to rectangular prism-shaped dispensers, and there is little differentiation among brands from one dispenser to another. Little innovation has been made with respect to product image and uniqueness of dispensers.

Therefore, a need exists for a consumer product dispenser that improves access to tissue sheets within the dispenser and presents a unique look to consumers.

### SUMMARY

Some aspects of the present disclosure relate to a dispenser for a plurality of sheets of sheet material. Some aspects relate to a dispenser that can be folded into multiple configurations. Some aspects relate to a dispenser that can be folded into multiple configurations by providing a plurality of fold lines on opposite panels of the dispenser.

Some aspects of the present disclosure relate to a blank that can be assembled into a dispenser for a plurality of sheets of sheet material. Some aspects relate to a blank that can be assembled into a dispenser that can be folded into multiple configurations. Some aspects relate to a blank that can be assembled into a dispenser that can be folded into multiple configurations by providing a plurality of fold lines on opposite panels of the dispenser.

Some aspects of the present disclosure relate to a dispenser that includes a dispensing panel having first and second edge, a first side panel having a dispensing edge and a base edge, a second side panel having a dispensing edge and a base edge, and a base panel having first and second edge. The dispensing edge of the first side panel is coupled to the first edge of the dispensing panel along a first primary fold line. The second edge of the dispensing panel is coupled to the dispensing edge of the second side panel along a second primary fold line. The base edge of the second side panel is coupled to the second edge of the base panel along a third primary fold line. The first side panel further defines at least one secondary fold line. Ends of the secondary fold line are disposed along one of the base edge or the dispensing edge of the first side panel, and a center of the secondary fold line is spaced apart from a center of the one of the base edge or the dispensing edge of the first side panel. The second side panel further defines at least one secondary fold line. Ends of the secondary fold line of the second side panel are disposed along one of the base edge or the dispensing edge of the second side panel, and a center of the secondary fold line is spaced apart from a center of the one of the base edge or the dispensing edge of the second side panel. The first side panel is coupled to the base panel such that the base edge of the first side panel, and the first edge of the base panel are adjacent each other. The dispenser is movable between a first configuration and a second configuration. In the first configuration, the base panel, the first side panel, the second side panel, and the dispensing panel are folded relative to each other along the primary fold lines. In the second configuration, the base panel or the dispensing panel, the first side panel, and the second side panel are folded relative to each other along the secondary fold lines.

In some aspects, in addition or in the alternative to the aspects disclosed herein, the secondary fold line of the first side panel is a first secondary fold line of the first side panel, and the secondary fold line of the second side panel is a first secondary fold line of the second side panel. The first side panel further includes a second secondary fold line. Ends of the second secondary fold line of the first side panel are disposed along the other of the dispensing edge or the base edge of the first side panel and a center of the second secondary fold line is spaced apart from a center of the one of the dispensing edge or the base edge of the first side panel. The second side panel further includes a second secondary fold line. Ends of the second secondary fold line of the second side panel are disposed along the other of the dispensing edge or the base edge of the second side panel and a center of the second secondary fold line of the second side panel is spaced apart from a center of the one of the dispensing edge or the base edge of the second side panel. The dispenser is movable among the first configuration, the second configuration, a third configuration, and a fourth configuration. In the third configuration, the dispensing panel or base panel, the first side panel, and the second side panel are folded relative to each other along the second secondary fold lines and the base panel or dispensing panel, the first side panel, and the second side panel are folded relative to each other along the primary fold lines. In the fourth configuration, the dispensing panel, base panel, the first side panel, and the second side panel are folded relative to each other along the first secondary fold lines and the second secondary fold lines.

In some aspects, in addition or in the alternative to any preceding aspects, the secondary fold lines are arcuate shaped.

In some aspects, in addition or in the alternative to any preceding aspects, the panels are rectangular shaped.

In some aspects, in addition or in the alternative to any preceding aspects, the ends of the first secondary fold line of the first side panel coincide with ends of the base edge of the first side panel, and the ends of the first secondary fold line of the second side panel coincide with ends of the base edge of the second side panel. In some implementations, the ends of the second secondary fold line of the first side panel coincide with ends of the dispensing edge of the first side panel, and the ends of the second secondary fold line of the second side panel coincide with ends of the dispensing edge of the second side panel.

In some aspects, in addition or in the alternative to any preceding aspects, the ends of the first secondary fold line of the first side panel coincide with ends of the dispensing edge of the first side panel, and the ends of the first secondary fold line of the second side panel coincide with ends of the dispensing edge of the second side panel. In some implementations, the ends of the second secondary fold line of the first side panel coincide with ends of the base edge of the first side panel and the ends of the second secondary fold line of the second side panel coincide with ends of the base edge of the second side panel.

In some aspects, in addition or in the alternative to any preceding aspects, the dispenser further includes a removable surfboard that is defined by a perforated or weakened line that couples the removable surfboard to the dispensing panel. The removable surfboard extends over a dispenser opening defined by the dispensing panel. The shape of the removable surfboard is coincident with the shape of the dispenser opening.

In some aspects, in addition or in the alternative to any preceding aspects, a base tab is coupled to the first edge of the base panel along a fourth primary fold line. The first edge of the base panel and the second edge of the base panel are opposite and spaced apart from each other, and a front surface of the tab is coupled to a rear surface of the first side panel such that the second edge of the base panel and the base edge of the first side panel are adjacent each other and the fourth primary fold line.

In some aspects, in addition or in the alternative to any preceding aspects, a first side panel tab extends from the first side panel along a first side fold line, and a second side panel tab extends from the first side panel along a second side fold line. The first side fold line and the second side fold line are spaced apart from each other and intersect respective ends of the base edge and the dispensing edge of the first side panel. A first side panel tab extends from the second side panel along a first side fold line, and a second side panel tab extends from the second side panel along a second side fold line. The first side fold line and the second side fold line of the second side panel are spaced apart from each other and intersect respective ends of the base edge and the dispensing edge of the second side panel. A first upper sidewall portion extends from the dispensing panel along a first side fold line, and a second upper sidewall portion extends from the dispensing panel along a second side fold line. The first and second side fold lines of the dispensing panel are spaced apart from each other and intersect respective ends of the first and second edges of the dispensing panel. A first lower sidewall portion extends from the base panel along a first side fold line, and a second lower sidewall portion extends from the base panel along a second side fold line. The first and second side fold lines of the base panel are spaced apart from each other and intersect respective ends of the first and second edges of the base panel. The first side panel tabs are disposed inwardly of the first lower sidewall portion and the first upper sidewall portion. The second side panel tabs are disposed inwardly of the second lower sidewall portion and the second upper sidewall portion. The upper sidewall portions and the lower sidewall portions are adhered together to form end sidewalls on each end of the dispenser. In some aspects, the upper and lower sidewall portions are also adhered to the respective side panel tabs.

Some aspects of the present disclosure relate to a blank for a dispenser for a plurality of sheets of sheet material. Some aspects relate to a blank that includes a dispensing panel having first and second edges, a first side panel having a dispensing panel edge and a base edge, a second side panel having a dispensing panel edge and a base edge, and a base panel having first and second edges. The dispensing edge of the first side panel is coupled to the first edge of the dispensing panel along a first primary fold line. The second edge of the dispensing panel is coupled to the dispensing edge of the second side panel along a second primary fold line. The base edge of the second side panel is coupled to the second edge of the base panel along a third primary fold line. The first side panel further defines at least one secondary fold line. Ends of the secondary fold line are disposed along one of the base edge or the dispensing edge of the first side panel, and a center of the secondary fold line is spaced apart from a center of the one of the base edge or dispensing edge of the first side panel. The second side panel further defines at least one secondary fold line. Ends of the secondary fold line of the second side panel are disposed along one of the base edge or the dispensing edge of the second side panel, and a center of the secondary fold line of the second side panel is spaced apart from a center of the one of the base edge or dispensing edge of the second side panel.

In some aspects, in addition or in the alternative to the aspects of the blank described above, the secondary fold line of the first side panel is a first secondary fold line, and the first side panel further includes a second secondary fold line. Ends of the second secondary fold line are disposed along the other of the dispensing edge or base edge of the first side panel, and a center of the second secondary fold line is spaced apart from a center of the other of the dispensing edge or the base edge of the first side panel. The secondary fold line of the second side panel is a first secondary fold line of the second side panel, and the second side panel further includes a second secondary fold line. Ends of the second secondary fold line of the second side panel are disposed along the other of the dispensing edge or the base edge of the second side panel, and a center of the second secondary fold line of the second side panel is spaced apart from a center of the other of the dispensing edge or the base edge of the second side panel.

In some aspects, in addition or in the alternative to any of the aspects of the blank described above, the secondary fold lines are arcuate shaped.

In some aspects, in addition or in the alternative to any of the aspects of the blank described above, the panels are rectangular shaped.

In some aspects, in addition or in the alternative to any of the aspects of the blank described above, the ends of the first secondary fold line of the first side panel coincide with the ends of the base edge of the first side panel, and the ends of the first secondary fold line of the second side panel coincide with ends of the base edge of the second side panel. In some implementations, the ends of the second secondary fold line of the first side panel coincide with ends of the dispensing edge of the first side panel, and the ends of the second secondary fold line of the second side panel coincide with ends of the dispensing edge of the second side panel.

In some aspects, in addition or in the alternative to any of the aspects of the blank described above, the ends of the first secondary fold line of the first side panel coincide with ends of the dispensing edge of the first side panel, and the ends of the first secondary fold line of the second side panel coincide with ends of the dispensing edge of the second side panel. In some implementations, the ends of the second secondary fold line of the first side panel coincide with ends of the base edge of the first side panel, and the ends of the second secondary fold line of the second side panel coincide with ends of the base edge of the second side panel.

In some aspects, in addition or in the alternative to any of the aspects of the blank described above, the blank further includes a removable surfboard that is defined by a perforated or weakened line that couples the removable surfboard to the dispensing panel. The removable surfboard extends over a dispenser opening defined by the dispensing panel. The shape of the removable surfboard is coincident with the shape of the dispenser opening.

In some aspects, in addition or in the alternative to any of the aspects of the blank described above, the base tab is coupled to the first edge of the base panel along a fourth primary fold line. The first edge of the base panel and the second edge of the base panel are opposite and spaced apart from each other.

In some aspects, in addition or in the alternative to any of the aspects of the blank described above, a first side panel tab extends from the first side panel along a first side fold line, and a second side panel tab extends from the first side panel along a second side fold line. The first side fold line and the second side fold line are spaced apart from each other and intersect respective ends of the base edge and the dispensing edge of the first side panel. A first side panel tab extends from the second side panel along a first side fold line, and a second side panel tab extends from the second side panel along a second side fold line. The first side fold line and the second side fold line of the second side panel are spaced apart from each other and intersect respective ends of the base edge and the dispensing edge of the second side panel. A first upper sidewall portion extends from the dispensing panel along a first side fold line, and a second upper sidewall portion extends from the dispensing panel along a second side fold line. The first and second side fold lines of the dispensing panel are spaced apart and intersect respective ends of the first and second edges of the dispensing panel. A first lower sidewall portion extends from the base panel along a first side fold line, and a second lower sidewall portion extends from the base panel along a second side fold line. The first and second side fold lines of the base panel are spaced apart and intersect respective ends of the first and second edges of the base panel.

Some aspects of the present disclosure relate to a method of forming a dispenser using a blank. Some aspects relate to a method of forming a dispenser using a blank, such as the blank implementations described above. In some aspects, the method includes: folding the first side panel relative to the dispensing panel along the first primary folding line in a first direction, wherein the first direction is a direction away from a customer-facing surface of the blank, folding the second side panel relative to the dispensing panel along the second primary fold line in the first direction, folding the base panel relative to the second side panel along the third primary fold line in the first direction, folding the first and second side panel tabs extending from the first side panel along the respective side fold lines in the first direction, folding the first and second side panel tabs extending from the second side panel along the respective side fold lines in the first direction, folding the first and second lower sidewall portions relative to the base panel along the respective side fold lines the first direction, folding the first and second upper sidewall portions relative to the dispensing panel along the respective side fold lines in the first direction, adhering the tab of the base panel and the first side panel such that the base edge of the first side panel and the first edge of the base panel are adjacent each other and the fourth primary fold line, adhering the first lower sidewall portion and the first upper sidewall portion such that the first side panel tabs are disposed inward of the first lower sidewall portion relative to the customer-facing surface of the blank, and adhering the second lower sidewall portion and the second upper sidewall portion such that the second side panel tabs are disposed inward of the second lower sidewall portion relative to the customer-facing surface of the blank. In some aspects, the upper and lower sidewall portions are also adhered to the respective side panel tabs.

In some aspects, in addition or in the alternative to the aspects of the method described above, the method of forming the dispenser using the blank includes: folding the panels relative to each other along the primary fold lines, and adhering the base panel and the first side panel together.

### BRIEF DESCRIPTION OF DRAWINGS

The above aspects and other features, aspects, and advantages of the present disclosure will become better understood with regard to the following description, appended claims, and accompanying drawings in which:

FIG. 1 shows a plan view of a blank for a dispenser, according to one implementation.

FIG. 2 shows a side view of a dispenser in a first configuration, according to one implementation.

FIG. 3 shows a side view of the dispenser in FIG. 2 in a second configuration.

FIG. 4 shows a perspective side view of the dispenser in FIG. 3.

FIG. 5 shows a plan view of the dispenser in FIG. 3.

### DETAILED DESCRIPTION

As used in the specification, and in the appended claims, the singular forms “a,” “an,” and “the” include plural referents unless the context clearly dictates otherwise. The terms “comprising,” “having,” and “including” and variations thereof as used herein are used synonymously and are open, non-limiting terms. Therefore, additional non-recited elements, functions, steps or limitations may be present in addition to the recited elements, functions, steps, or limitations.

As used herein, “sheet-material” is a flexible substrate, which is useful for household chores, cleaning, personal care, health care, food wrapping, and cosmetic application or removal. Non-limiting examples of suitable substrates for use with the dispenser include nonwoven substrates, woven substrates, hydro-entangled substrates, air-entangled substrates, paper substrates comprising cellulose (such as tissue paper, toilet paper, or paper towels), waxed paper substrates, coform substrates comprising cellulose fibers and polymer fibers, wet substrates such as wet wipes, moist cleaning wipes, moist toilet paper wipes, baby wipes, film, or plastic substrates (such as those used to wrap food), shop towels, and metal substrates such as aluminum foil. Furthermore, laminated or plied together substrates of two or more layers of any of the preceding substrates are also suitable.

As used here, “fold line” is a line of weakness, which may be continuous or discontinuous, disposed on the dispenser or blank for forming the same. Lines of weakness may be created by creasing, mechanical scoring, laser scoring, stamping, cutting, perforating, or the like. Fold lines may be disposed between adjacent panels of the dispenser to facilitate folding of one panel relative to the other. In some instances, a fold line may be disposed within a given panel to facilitate reconfiguration of the given panel. As shown in the drawings, the broken lines labeled as 110, 112, 114, 116, 120, 130, 180, 190, 158, 160, 162, 164, 166, 168, 170, and 172 are examples of lines of weakness formed by creases that are suitable for folding.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of exemplary aspects.

It is to be understood by one of ordinary skill in the art that the present discussion is a description of exemplary implementations only and is not intended as limiting the broader aspects of the present disclosure, which broader aspects are embodied in the exemplary construction.

Generally, a consumer product dispenser, such as a facial tissue dispenser, is sold to a consumer in a first configuration having a rectangular prism shape and houses a plurality of sheets formed from sheet-material. The sheets can be interfolded for pop-up dispensing and formed into a stack. The stack sits within the dispenser and is configured for sheets to be pulled from the stack and out of the dispenser, normally one at a time.

When the volume of sheets in a stack becomes low, it may be difficult for consumers to access the next sheet in the stack. For example, when one sheet is pulled out of the dispenser, the next sheet in the stack may not pop-up or may fall back into the dispenser.

Various implementations include a dispenser comprising a plurality of fold lines that facilitate the dispenser being moved between at least two configurations by folding the dispenser along one or more different fold lines for each configuration. In some implementations, at least one of the configurations reduces the distance between a dispenser opening for accessing the sheets and a top of the sheet stack disposed within the dispenser, which makes it easier for the consumer to access the sheets, as compared to another configuration.

Additionally, in some implementations, the shape of the fold lines that allow the dispenser to be folded into non-rectangular prism configurations contributes to a unique look for a dispenser and a blank.

In some implementations, the dispenser is formed from a recyclable material, such as paperboard, that can be scored and folded into multiple configurations.

According to various implementations, the dispenser is created by folding a blank-a flat sheet of material (e.g., paperboard) that is cut and provided with a plurality of fold lines-along the plurality of fold lines and coupling portions of the blank together (e.g., using adhesive).

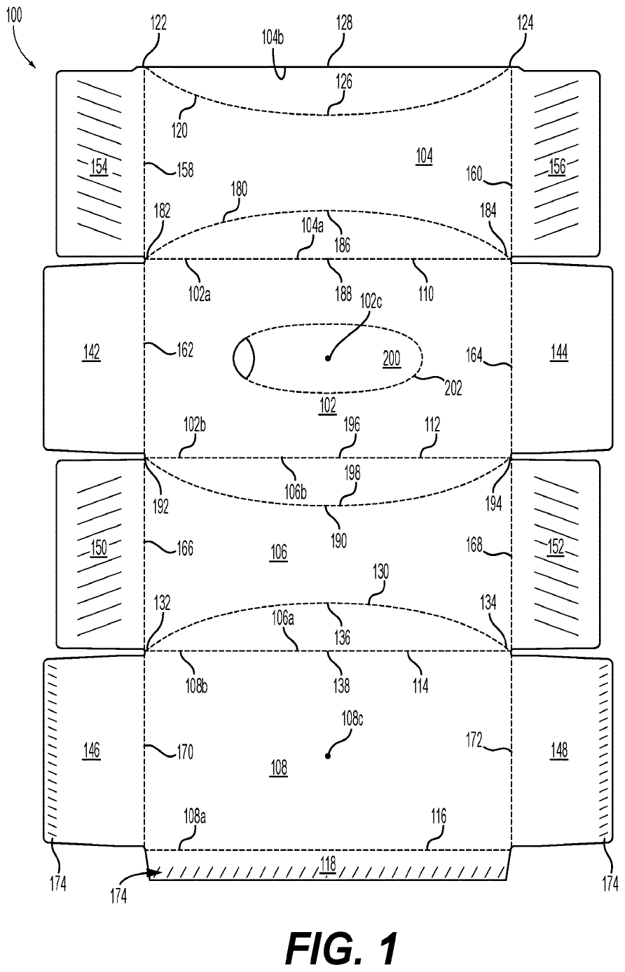

For example, FIG. 1 shows a blank 100 for a dispenser for a plurality of sheets of sheet-material, according to one implementation. Sheet materials may include, for example, facial tissues, bath tissue, paper towels, or wipes that may be dispensed one at a time from a dispenser. The blank 100 includes a dispensing panel 102 having a first edge 102a and a second edge 102b, a first side panel 104 having a dispensing edge 104a and a base edge 104b, a second side panel 106 having a dispensing edge 106b and a base edge 106a, and a base panel 108 having a first edge 108a and second edge 108b.

The dispensing edge 104a of the first side panel 104 is coupled to the first edge 102a of the dispensing panel 102 along a first primary fold line 110. The second edge 102b of the dispensing panel 102 is coupled to the dispensing edge 106b of the second side panel 106 along a second primary fold line 112. The base edge 106a of the second side panel 106 is coupled to the second edge 108b of the base panel 108 along a third primary fold line 114.

The first side panel 104 further defines a first secondary fold line 120 and a second secondary fold line 180. Ends 122, 124 of the secondary fold line 120 are disposed along the base edge 104b of the first side panel 104. In the implementation shown in FIG. 1, the ends 122, 124 are coincident with the ends of the base edge 104b. A center 126 of the secondary fold line 120 is spaced apart from a center 128 of the base edge 104b of the first side panel 104. Ends 182, 184 of the second secondary fold line 180 are disposed along the dispensing edge 104a of the first side panel 104. In the implementation shown in FIG. 1, the ends 182, 184 are coincident with the ends of the dispensing edge 104a. A center 186 of the second secondary fold line 180 is spaced apart from a center 188 of the dispensing edge 104a of the first side panel 104.

The second side panel 106 further defines a first secondary fold line 130 and a second secondary fold line 190. Ends 132, 134 of the first secondary fold line 130 of the second side panel 106 are disposed along the base edge 106a of the second side panel 106. In the implementation shown in FIG. 1, the ends 132, 134 are coincident with the ends of the base edge 106a. A center 136 of the first secondary fold line 130 of the second side panel 106 is spaced apart from a center 138 of the base edge 106a of the second side panel 106. Ends 192, 194 of the second secondary fold line 190 of the second side panel 106 are disposed along the dispensing edge 106b of the second side panel 106. In the implementation shown in FIG. 1, the ends 192, 194 are coincident with the ends of the dispensing edge 106b. A center 198 of the second secondary fold line 190 of the second side panel 106 is spaced apart from a center 196 of the dispensing edge 106b of the second side panel 106.

The secondary fold lines 120, 130, 180, 190 shown in FIG. 1 are arcuate shaped. However, in other implementations, the secondary fold lines may have another shape, such as being partially arcuate and partially straight, having an elliptical or a circular shape, or including a plurality of straight lines (e.g., triangular shaped, trapezoidal shaped).

The panels 102, 104, 106, 108 in FIG. 1 are rectangular shaped. However, in other implementations, one or more of the panels may have another shape, for example, a triangle, pentagon, hexagon, octagon, or another shape with three or more straight edges. In other implementations, one or more of the panels may have an irregular shape with arcuate portions. In other implementations, one or more of the panels may have a shape including both straight edges and arcuate portions formed together.

In other implementations, the panels may be in a different order (e.g., the base panel 108 coupled between the first and second side panels 104, 106 while the dispensing panel 102 is coupled to only one of the first and second side panels 104, 106.

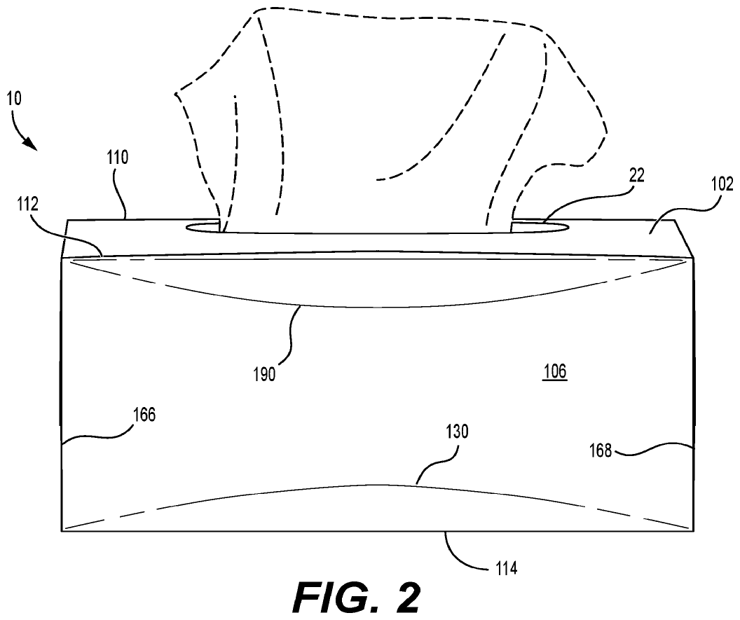

Although the ends of the secondary fold lines shown in FIGS. 1 and 2 are coincident with the ends of the respective base and dispensing edges, in other implementations, at least one of the ends of each secondary fold line do not coincide with the ends of the corresponding base edge or dispensing edge.

As shown in FIG. 1, the dispensing panel 102 further includes a removable surfboard 200. The removable surfboard is defined by a perforated line 202 that couples the removable surfboard to the dispensing panel 102. The removable surfboard 200 extends over a dispenser opening defined by the dispensing panel 102. The shape of the removable surfboard 200 is coincident with the shape of the dispenser opening.

The blank 100 further includes a base tab 118 coupled to the first edge 108a of the base panel 108 along a fourth primary fold line 116. The first edge 108a of the base panel 108 and the second edge 108b of the base panel 108 are opposite and spaced apart from each other. The base tab 118 extends along the length of the first edge 108a, but in other implementations, the base tab 118 may extend along a portion of the length of the first edge 108a, or the base tab 118 may include a plurality of portions that are spaced apart along the length of the first edge 108a. The base tab 118 is configured for being adhered or otherwise coupled to an inner surface of the first side panel 104 such that the base edge 104b of the first side panel 104 is adjacent to the first edge 108a of the base panel 108.

The blank 100 further includes a first side panel tab 154 extending from the first side panel 104 along a first side fold line 158 and a second side panel tab 156 extending from the first side panel 104 along a second side fold line 160. The first side fold line 158 and the second side fold line 160 are spaced apart from each other and intersect respective ends of the base edge 104b and the dispensing edge 104a of the first side panel 104.

The blank 100 further includes a first side panel tab 150 extending from the second side panel 106 along a first side fold line 166 and a second side panel tab 152 extending from the second side panel 106 along a second side fold line 168. The first side fold line 166 and the second side fold line 168 of the second side panel 106 are spaced apart from each other and intersect respective ends of the base edge 106a and the dispensing edge 106b of the second side panel 106.

The blank 100 further includes a first upper sidewall portion 142 extending from the dispensing panel 102 along a first side fold line 162 and a second upper sidewall portion 144 extending from the dispensing panel 102 along a second side fold line 164. The first and second side fold lines 162, 164 of the dispensing panel are spaced apart from each other and intersect respective ends of the first and second edges 102a, 102b of the dispensing panel 102.

The blank 100 further includes a first lower sidewall portion 146 extending from the base panel 108 along a first side fold line 170 and a second lower sidewall portion 148 extending from the base panel 108 along a second side fold line 172. The first and second side fold lines 170, 172 of the base panel 108 are spaced apart from each other and intersect respective ends of the first and second edges 108a, 108b of the base panel 108.

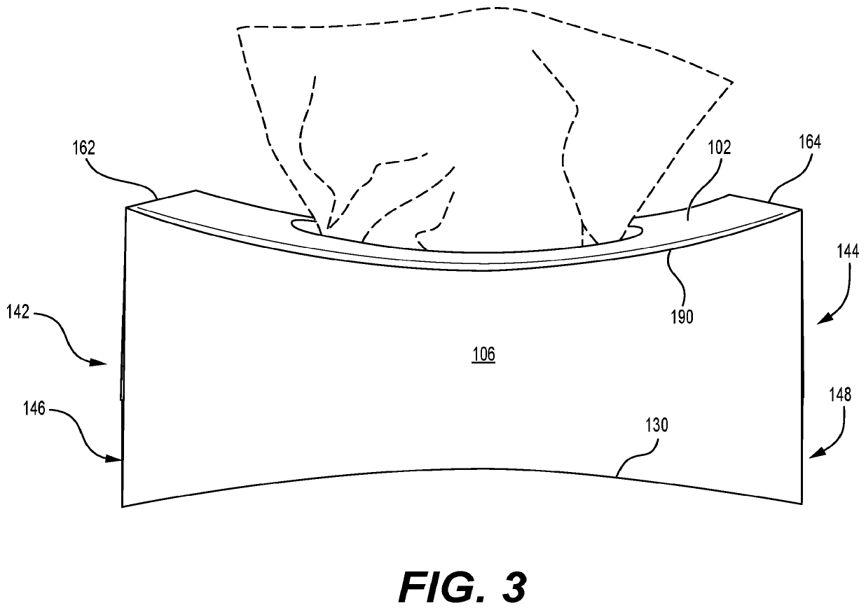

The blank 100 includes adhesive areas 174. As shown in FIG. 1, the adhesive areas 174 are marked with diagonal lines and appear on portions of the tab 118, the first and second side panel tabs 154, 156 of the first side panel 104, the first and second side panel tabs 150, 152 of the second side panel 106, and the first and second lower sidewall portions 146, 148 of the base panel 108. Adhesive applied to these areas is used to secure the blank in folded configurations, which are shown in FIGS. 2 and 3 and are described below. In other implementations, the adhesive areas may cover a greater portion of the tabs, sidewall portions, and side panels, for example, such that adhesive covers substantially all of that particular surface. In other implementations, the adhesive areas may cover a smaller portion of the abovementioned surfaces (e.g., small dots or areas of adhesive arranged in each surface).

The blank 100 may be printed or embossed/debossed with labeling, such as the brand of the tissues, the number of tissues within the dispenser, or other information that the consumer may want to know.

The blank 100 is configured to be folded, creased, and/or glued together to form a dispenser, such as dispenser 10 shown in FIGS. 2-5. The formation of dispenser 10 using the blank 100 includes the following steps:
(i) folding the first side panel 104 relative to the dispensing panel 102 along the first primary folding line 110 in a first direction, wherein the first direction is a direction away from a surface (shown in the plan view in FIG. 1) of the blank that is to be the outer surface of the dispenser;
(ii) folding the second side panel 106 relative to the dispensing panel 102 along the second primary fold line 112 in the first direction;
(iii) folding the base panel 108 relative to the second side panel 106 along the third primary fold line 114 in the first direction;
(iv) folding the first and second side panel tabs 154, 156 extending from the first side panel 104 along the respective side fold lines 158, 160 in the first direction;
(v) folding the first and second side panel tabs 150, 152 extending from the second side panel 106 along the respective side fold lines 166, 168 in the first direction;
(vi) folding the first and second lower sidewall portions 146, 148 relative to the base panel 108 along the respective side fold lines 170, 172 the first direction;
(vii) folding the first and second upper sidewall portions 142, 144 relative to the dispensing panel 102 along the respective side fold lines 162, 164 in the first direction;
(viii) adhering the tab 118 of the base panel 108 and the first side panel 104 such that the base edge 104b of the first side panel 104 and the first edge 108a of the base panel 108 are adjacent each other and the fourth primary fold line 116;
(ix) adhering the first lower sidewall portion 146 and the first upper sidewall portion 142 such that the first side panel tabs 154, 156 are disposed inward of the first lower sidewall portion 146 relative to the customer-facing surface of the blank; and
(x) adhering the second lower sidewall portion 148 and the second upper sidewall portion 144 such that the second side panel tabs 150, 152 are disposed inward of the second lower sidewall portion 148 relative to the customer-facing surface of the blank. The upper sidewall portions 142, 144 and the lower sidewall portions 146, 148 are adhered together to form end sidewalls on each end of the dispenser 10. These sidewall portions 142, 144, 146, 148 may also be adhered to the respective side panel tabs 150, 152, 154, 156. These steps may be performed in the order listed, but the steps may be performed in another suitable order according to other implementations.

Dispenser 10 shown in FIG. 2 dispenses a plurality of sheets of sheet-materials, such as facial tissue sheets, bath tissue, or paper towel sheets. In some implementations, the sheets are dispensed through the dispenser opening 22 defined by the dispensing panel 102 after the removable surfboard 200 is removed from the dispensing panel 102 by separating it from the panel 102 via the perforations 202.

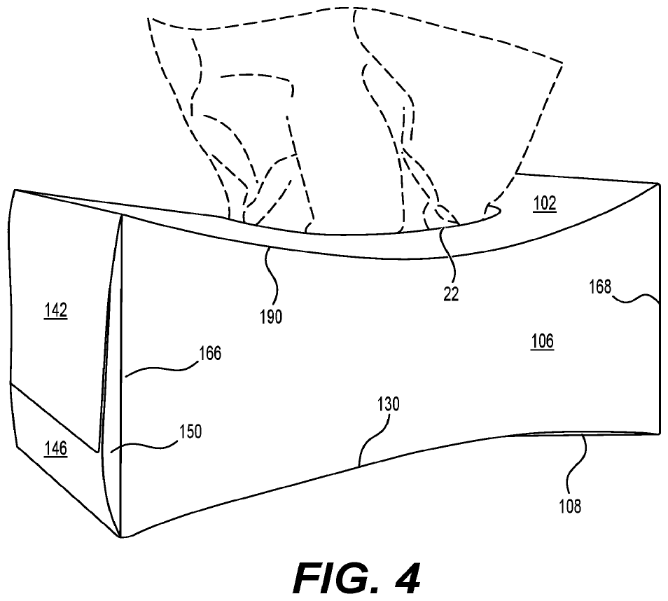

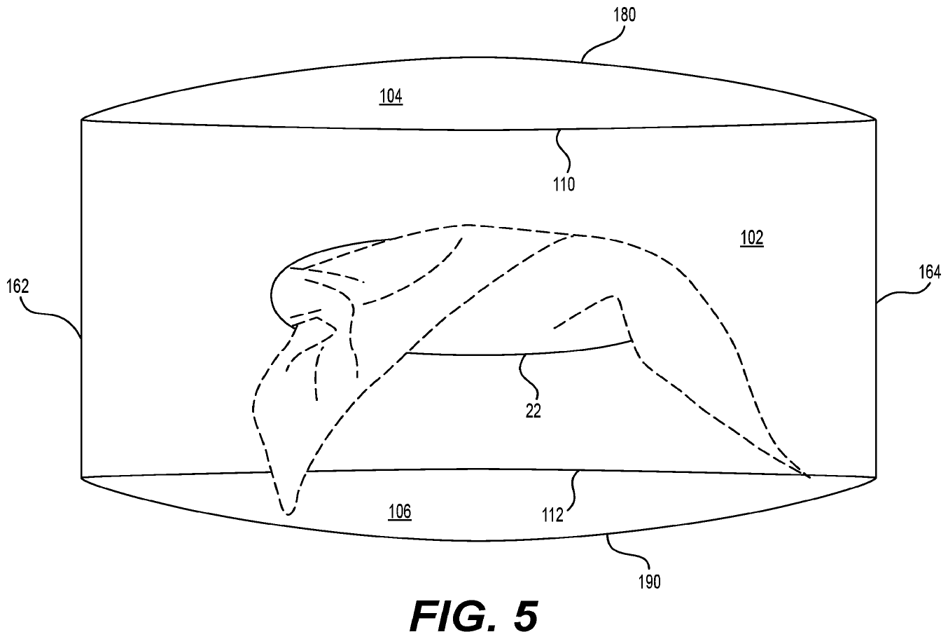

FIG. 2 shows a side view of an assembled dispenser 10 in a first configuration. The dispenser 10 is movable between a first configuration and a second configuration, which is shown in FIGS. 3-5. In the first configuration, the base panel 108, the first side panel 104, the second side panel 106, and the dispensing panel 102 are folded relative to each other along the primary fold lines 110, 112, 114, 116. The dispenser 10 generally has a rectangular prism shape in the first configuration shown in FIG. 2. In the second configuration, which is shown in FIGS. 3-5, the first side panel 104, the second side panel 106, and the base panel 108 and dispensing panel 102 are folded relative to each other along the secondary fold lines 120, 130, 180, 190. In the second configuration, the portions of the side panels between the secondary fold lines and the primary fold lines that they intersect bow outwardly from the dispensing panel and base panels, as seen from plan view in FIG. 5, and follow the same inwardly curved contour as the dispensing panel and the base panel, as seen from the side view and perspective view of FIGS. 3 and 4.

The dispenser 10 is also movable among the first configuration, the second configuration, a third configuration, and a fourth configuration. In the third configuration, the base panel 108, the first side panel 104, and the second side panel 106 are folded relative to each other along the secondary fold lines 120, 130. The dispensing panel 102, the first side panel 104, and the second side panel 106 are folded relative to each other along the primary fold lines 110, 112.

In the fourth configuration, the dispensing panel 102, the first side panel 104, and the second side panel 106 are folded relative to each other along the secondary fold lines 180, 190. The base panel 108, the first side panel 104, and the second side panel 106 are folded relative to each other along the primary fold lines 114, 116.

When the dispenser 10 is moved from the first configuration to the second configuration, the height of the stack of sheets of sheet-material in the dispenser 10 is the same or less than the height between the centers of the secondary fold lines on each side panel, allowing central portions of the dispensing panel 102 and the base panel 108 to move closer to each other. By moving the dispenser 10 from the first configuration to the second configuration, for example, by pushing the dispensing panel 102 and the base panel 108 toward each other, a central portion of the dispensing panel 102 and a central portion of the base panel 108 move toward the other when the side panels 104, 106 are folded about the secondary fold lines. More specifically, a central point 102c of the dispensing panel 102 is disposed closer to a central point 108c of the base panel 108 in the second configuration as compared to the first configuration.

Folding the side panels 104, 106 about the first secondary fold lines 120, 130 moves the stack of sheets of sheet-material toward the central point 102c of dispensing panel 102, and folding the side panels 104, 106 about the second secondary fold lines 180, 190 moves the central point 102c of dispensing panel 102 closer to the sheets of sheet-material.

When the dispenser 10 is moved from the first configuration to the second configuration, portions of the first side panel 104 and the second side panel 106 become flush with the surface contours of the dispensing panel 102 and the base panel 108. For example, a portion of the first side panel 104 between dispensing edge 104a, second secondary fold line 180, and ends 182, 184 is moved from being substantially flush with first side panel 104 in the first configuration to being substantially flush with dispensing panel 102 in the second configuration.

Further, a portion of the first side panel 104 between base edge 104b, first secondary fold line 120, and ends 122, 124 is moved from being substantially flush with first side panel 104 in the first configuration to being substantially flush with base panel 108 in the second configuration. Similarly, a portion of the second side panel 106 between dispensing edge 106b, second secondary fold line 190, and ends 192, 194 is moved from being substantially flush with second side panel 106 in the first configuration to being substantially flush with dispensing panel 102 in the second configuration. Further, a portion of the second side panel 106 between base edge 106a, first secondary fold line 130, and ends 132, 134 is moved from being substantially flush with second side panel 106 in the first configuration to being substantially flush with base panel 108 in the second configuration.

In other implementations (not shown), the side panels include other fold lines in addition to those already listed (e.g., tertiary fold lines and/or quaternary fold lines). In other implementations (not shown), the side panels include fold lines (e.g., first, secondary, tertiary, and/or quaternary fold lines). In other implementations (not shown), the side panels include an array of additional fold lines capable of folding the dispenser into more configurations (e.g., fifth and sixth configurations). In some implementations (not shown), corresponding fold lines may be disposed on the upper sidewall portions and lower sidewall portions such that some configurations of the dispenser include fold lines extending across two or more surfaces in a continuous manner. In some implementations (not shown), the dispenser may take on an accordion shape based upon the array of fold lines disposed on the side panels and/or the sidewall portions.

As seen in FIG. 2, one sheet may extend out of the dispenser 10 to be grabbed and pulled away from the dispenser 10. The remainder of sheets are held within the dispenser 10, which is not shown in FIG. 2. In some implementations, the remainder of sheets are interfolded and held within the dispenser in a stack for pop-up dispensing. Pop-up dispensing allows a next remainder sheet to be pulled through the opening and extend out of the dispenser 10, ready to be pulled away just like the sheet before it.

A number of example implementations are provided herein. However, it is understood that various modifications can be made without departing from the spirit and scope of the disclosure herein.

Disclosed are materials, systems, devices, methods, compositions, and components that can be used for, can be used in conjunction with, can be used in preparation for, or are products of the disclosed methods, systems, and devices.

These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A dispenser for a plurality of sheets of sheet materials, the dispenser comprising:
a dispensing panel having first and second edges;
a first side panel having a dispensing edge and a base edge;
a second side panel having a dispensing edge and a base edge; and
a base panel having first and second edges;
wherein:
the dispensing edge of the first side panel is coupled to the first edge of the dispensing panel along a first primary fold line,
the second edge of the dispensing panel is coupled to the dispensing edge of the second side panel along a second primary fold line,
the base edge of the second side panel is coupled to the second edge of the base panel along a third primary fold line,
the first side panel further defines at least one secondary fold line, wherein ends of the secondary fold line are disposed along one of the base edge or the dispensing edge of the first side panel and a center of the secondary fold line is spaced apart from a center of the one of the base edge or the dispensing edge of the first side panel,
the second side panel further defines at least one secondary fold line, wherein ends of the secondary fold line of the second side panel are disposed along one of the base edge or the dispensing edge of the second side panel and a center of the secondary fold line is spaced apart from a center of the one of the base edge or the dispensing edge of the second side panel,
the first side panel is coupled to the base panel such that the base edge of the first side panel and the first edge of the base panel are adjacent each other, and
the dispenser is movable between a first configuration and a second configuration, wherein in the first configuration, the base panel, the first side panel, the second side panel, and the dispensing panel are folded relative to each other along the primary fold lines, and in the second configuration, the base panel or the dispensing panel, the first side panel, and the second side panel are folded relative to each other along the secondary fold lines.

2. The dispenser of claim 1, wherein:
the secondary fold line of the first side panel is a first secondary fold line of the first side panel, and the secondary fold line of the second side panel is a first secondary fold line of the second side panel,
the first side panel further comprises a second secondary fold line, wherein ends of the second secondary fold line of the first side panel are disposed along the other of the dispensing edge or the base edge of the first side panel and a center of the second secondary fold line is spaced apart from a center of the one of the dispensing edge or the base edge of the first side panel,
the second side panel further comprises a second secondary fold line, wherein ends of the second secondary fold line of the second side panel are disposed along the other of the dispensing edge or the base edge of the second side panel and a center of the second secondary fold line of the second side panel is spaced apart from a center of the one of the dispensing edge or the base edge of the second side panel,
the dispenser is movable among the first configuration, the second configuration, a third configuration, and a fourth configuration,
in the third configuration, the dispensing panel or base panel, the first side panel, and the second side panel are folded relative to each other along the second secondary fold lines and the base panel or dispensing panel, the first side panel, and the second side panel are folded relative to each other along the primary fold lines, and
in the fourth configuration, the dispensing panel, base panel, the first side panel, and the second side panel are folded relative to each other along the first secondary fold lines and the second secondary fold lines.

3. The dispenser of claim 1, wherein the secondary fold lines are arcuate shaped.

4. The dispenser of claim 1, wherein the panels are rectangular shaped.

5. The dispenser of claim 1, wherein the ends of the first secondary fold line of the first side panel coincide with ends of the base edge of the first side panel and the ends of the first secondary fold line of the second side panel coincide with ends of the base edge of the second side panel.

6. The dispenser of claim 5, wherein the ends of the second secondary fold line of the first side panel coincide with ends of the dispensing edge of the first side panel and the ends of the second secondary fold line of the second side panel coincide with ends of the dispensing edge of the second side panel.

7. The dispenser of claim 1, wherein the ends of the first secondary fold line of the first side panel coincide with ends of the dispensing edge of the first side panel and the ends of the first secondary fold line of the second side panel coincide with ends of the dispensing edge of the second side panel.

8. The dispenser of claim 7, wherein the ends of the second secondary fold line of the first side panel coincide with ends of the base edge of the first side panel and the ends of the second secondary fold line of the second side panel coincide with ends of the base edge of the second side panel.

9. The dispenser of claim 1, further comprising a removable surfboard, wherein the removable surfboard is defined by a perforated or weakened line on the dispensing panel.

10. The dispenser of claim 1, wherein a base tab is coupled to the first edge of the base panel along a fourth primary fold line, wherein the first edge of the base panel and the second edge of the base panel are opposite and spaced apart from each other, and a front surface of the tab is coupled to a rear surface of the first side panel such that the second edge of the base panel and the base edge of the first side panel are adjacent each other and the fourth primary fold line.

11. The dispenser of claim 1, wherein:
a first side panel tab extends from the first side panel along a first side fold line and a second side panel tab extends from the first side panel along a second side fold line, the first side fold line and the second side fold line being spaced apart from each other and intersecting respective ends of the base edge and the dispensing edge of the first side panel,
a first side panel tab extends from the second side panel along a first side fold line and a second side panel tab extends from the second side panel along a second side fold line, the first side fold line and the second side fold line of the second side panel being spaced apart from each other and intersecting respective ends of the base edge and the dispensing edge of the second side panel,
a first upper sidewall portion extends from the dispensing panel along a first side fold line and a second upper sidewall portion extends from the dispensing panel along a second side fold line, the first and second side fold lines of the dispensing panel being spaced apart from each other and intersecting respective ends of the first and second edges of the dispensing panel,
a first lower sidewall portion extends from the base panel along a first side fold line and a second lower sidewall portion extends from the base panel along a second side fold line, the first and second side fold lines of the base panel being spaced apart from each other and intersecting respective ends of the first and second edges of the base panel, and
the first side panel tabs are disposed inwardly of the first lower sidewall portion and the first upper sidewall portion,
the second side panel tabs are disposed inwardly of the second lower sidewall portion and the second upper sidewall portion, and
the upper sidewall portions and the lower sidewall portions are adhered together to form end sidewalls on each end of the dispenser.

12. A blank for a dispenser for a plurality of sheets of sheet materials, the blank comprising:
a dispensing panel having first and second edges;
a first side panel having a dispensing panel edge and a base edge;
a second side panel having a dispensing panel edge and a base edge; and
a base panel having first and second edges;
wherein:
the dispensing edge of the first side panel is coupled to the first edge of the dispensing panel along a first primary fold line,
the second edge of the dispensing panel is coupled to the dispensing edge of the second side panel along a second primary fold line,
the base edge of the second side panel is coupled to the second edge of the base panel along a third primary fold line,
the first side panel further defines at least one secondary fold line, wherein ends of the secondary fold line are disposed along one of the base edge or the dispensing edge of the first side panel and a center of the secondary fold line is spaced apart from a center of the one of the base edge or dispensing edge of the first side panel, and
the second side panel further defines at least one secondary fold line, wherein ends of the secondary fold line of the second side panel are disposed along one of the base edge or the dispensing edge of the second side panel and a center of the secondary fold line of the second side panel is spaced apart from a center of the one of the base edge or dispensing edge of the second side panel.

13. The blank of claim 12, wherein:
the secondary fold line of the first side panel is a first secondary fold line, and the first side panel further comprises a second secondary fold line, wherein ends of the second secondary fold line are disposed along the other of the dispensing edge or base edge of the first side panel and a center of the second secondary fold line is spaced apart from a center of the other of the dispensing edge or the base edge of the first side panel, and
the secondary fold line of the second side panel is a first secondary fold line of the second side panel, and the second side panel further comprises a second secondary fold line, wherein ends of the second secondary fold line of the second side panel are disposed along the other of the dispensing edge or the base edge of the second side panel and a center of the second secondary fold line of the second side panel is spaced apart from a center of the other of the dispensing edge or the base edge of the second side panel.

14. The blank of claim 12, wherein the secondary fold lines are arcuate shaped.

15. The blank of claim 12, wherein the panels are rectangular shaped.

16. The blank of claim 12, wherein the ends of the first secondary fold line of the first side panel coincide with ends of the base edge of the first side panel and the ends of the first secondary fold line of the second side panel coincide with ends of the base edge of the second side panel.

17. The blank of claim 16, wherein the ends of the second secondary fold line of the first side panel coincide with ends of the dispensing edge of the first side panel and the ends of the second secondary fold line of the second side panel coincide with ends of the dispensing edge of the second side panel.

18. The blank of claim 12, wherein the ends of the first secondary fold line of the first side panel coincide with ends of the dispensing edge of the first side panel and the ends of the first secondary fold line of the second side panel coincide with ends of the dispensing edge of the second side panel.

19. The blank of claim 18, wherein the ends of the second secondary fold line of the first side panel coincide with ends of the base edge of the first side panel and the ends of the second secondary fold line of the second side panel coincide with ends of the base edge of the second side panel.

20. The blank of claim 12, further comprising a removable surfboard, wherein the removable surfboard is defined by a perforated or weakened line on the dispensing panel.

21. The blank of claim 12, wherein a base tab is coupled to the first edge of the base panel along a fourth primary fold line, wherein the first edge of the base panel and the second edge of the base panel are opposite and spaced apart from each other.

22. The blank of claim 12, wherein:
a first side panel tab extends from the first side panel along a first side fold line and a second side panel tab extends from the first side panel along a second side fold line, the first side fold line and the second side fold line being spaced apart from each other and intersecting respective ends of the base edge and the dispensing edge of the first side panel,
a first side panel tab extends from the second side panel along a first side fold line and a second side panel tab extends from the second side panel along a second side fold line, the first side fold line and the second side fold line of the second side panel being spaced apart from each other and intersecting respective ends of the base edge and the dispensing edge of the second side panel,
a first upper sidewall portion extends from the dispensing panel along a first side fold line and a second upper sidewall portion extends from the dispensing panel along a second side fold line, the first and second side fold lines of the dispensing panel being spaced apart and intersecting respective ends of the first and second edges of the dispensing panel,
a first lower sidewall portion extends from the base panel along a first side fold line and a second lower sidewall portion extends from the base panel along a second side fold line, the first and second side fold lines of the base panel being spaced apart and intersecting respective ends of the first and second edges of the base panel.

23. A method of forming a dispenser using the blank of claim 12, wherein the method comprises:
folding the first side panel relative to the dispensing panel along the first primary folding line in a first direction, wherein the first direction is a direction away from a customer-facing surface of the blank,
folding the second side panel relative to the dispensing panel along the second primary fold line in the first direction,
folding the base panel relative to the second side panel along the third primary fold line in the first direction,
folding the first and second side panel tabs extending from the first side panel along the respective side fold lines in the first direction,
folding the first and second side panel tabs extending from the second side panel along the respective side fold lines in the first direction,
folding the first and second lower sidewall portions relative to the base panel along the respective side fold lines the first direction, folding the first and second upper sidewall portions relative to the dispensing panel along the respective side fold lines in the first direction,
adhering the tab of the base panel and the first side panel such that the base edge of the first side panel and the first edge of the base panel are adjacent each other and the fourth primary fold line,
adhering the first lower sidewall portion and the first upper sidewall portion such that the first side panel tabs are disposed inward of the first lower sidewall portion relative to the customer-facing surface of the blank, and
adhering the second lower sidewall portion and the second upper sidewall portion such that the second side panel tabs are disposed inward of the second lower sidewall portion relative to the customer-facing surface of the blank.

24. The method of claim 23, further comprising:
folding the panels relative to each other along the primary fold lines, and adhering the base panel and the first side panel together.
